(19) United States
(12) Patent Application Publication
(10) Pub. No.: US 2011/0160030 A1
(43) Pub. Date: Jun. 30, 2011

(54) Laboratory centrifuge with compressor cooling

(76) Inventors: Andreas Heilmann, Borsdorf (DE); Heiko Mueller, Borsdorf (DE); Kai Marschner, Halle (DE); Bert-Olaf Grimm, Leipzig (DE)

(21) Appl. No.: 12/928,701

(22) Filed: Dec. 16, 2010

Related U.S. Application Data
(60) Provisional application No. 61/284,365, filed on Dec. 17, 2009.

(51) Int. Cl. B04B 15/02

(52) U.S. Cl. 494/14

(57) ABSTRACT

A laboratory centrifuge according to the invention provides much better de-mixing rates of centrifuged samples since providing at least one rotation compressor introduces substantially less vibration into the laboratory centrifuge, so that much lower remixing rates are provided.

### RELATED APPLICATIONS

This application claims priority from and incorporates by reference U.S. provisional patent application 61/284,365, filed on Dec. 17, 2009.

### FIELD OF THE INVENTION

The present invention relates to a laboratory centrifuge, and more particularly to a laboratory centrifuge including a rotor driven by a centrifuge motor and a cooling device including a compressor, wherein the compressor is a rotation compressor.

### BACKGROUND OF THE INVENTION

Laboratory centrifuges of this type are being used in biological, chemical and medical labs for de-mixing various components of a liquid, or separating solids from a liquid. Thus, a centrifugal force is being used, which has different effects on different masses.

In current laboratory centrifuges, typically rotational speeds of up to 16,000 revolutions per minute are generated, which generates accelerations up to 21×9.81 m/s². However, it is apparent that such centrifuges do not provide complete or satisfactory de-mixing of liquid samples. Thus, centrifuges are being developed in which de-mixing shall be improved through higher speeds of rotation of up to 25,000 revolutions per minute.

This, however, causes a strong increase in heating since on the one hand the motor of the centrifuge rotor dissipates heat. This heat can mostly be kept away from the samples treated in the centrifuge through thermal insulation. However, the heat is created among other things in that a fast rotation is performed under aerial drag. The heating of samples thus caused cannot easily be prevented since a rotation under vacuum is not possible for laboratory centrifuges for cost reasons.

The heat thus created causes substantial heating of the centrifuged samples which can easily lead to their destruction or non-usability. Typically, the samples have to be maintained at defined temperatures, for example, depending on the application, temperatures of 4° C., 22° C. or 37° C.

In order to prevent an increase of the sample temperature above these values typically passive or active cooling devices are provided in the laboratory centrifuge, wherein compressors are typically used for active cooling, thus reciprocating piston compressors.

### BRIEF SUMMARY OF THE INVENTION

Thus it is the object of the present invention to provide laboratory centrifuges which facilitate a higher de-mixing rate of the centrifuged samples.

This object is achieved through a laboratory centrifuge including a rotor driven by a centrifuge motor and a cooling device including a compressor, wherein the compressor is a rotation compressor. Further advantageous embodiments of the laboratory centrifuge include the following, taken alone or in any combination:
wherein the rotation compressor is a compressor selected from a group consisting of rotating piston compressor, scroll compressor, vane type compressor, wobble plate compressor, screw compressor, spiral compressor and rotary piston compressor;
wherein the rotation compressor is an electrically driven, in particular DC and/or AC power driven compressor;
wherein at least two compressors are disposed in parallel;
wherein the laboratory centrifuge is a table top laboratory centrifuge, a micro liter centrifuge or similar; and
wherein a remixing rate is less than or equal to 20%, preferably less than or equal to 17%, in particular less than or equal to 14%.

Surprisingly the inventors have found that the de-mixing rates of the centrifuged samples can be increased in that rotation compressors are used for active refrigeration within the laboratory centrifuge.

This finding is based on the fact that the centrifuge power does not determine the de-mixing rate, but the remixing rate caused by the laboratory centrifuge determines the de-mixing rate.

So far laboratory centrifuges only use reciprocating piston compressors for centrifuge compressors, due to their relatively small size compared to their power. In such reciprocating piston compressors the compressing element performs a purely linear movement in the compression cavity. Compressors which operate according to this compression principle are therefore also designated as linear compressors. Linear compressors have dead centers in the motion of the compressing element which make the compressor vibrate violently during start up and shut down. The vibrations cannot be kept completely separate from the rotator of the centrifuge, since the compressor and the rotator are disposed in an integral housing in the laboratory centrifuge.

Thus, the inventors have found that the vibrations significantly contribute to the high remixing rates of such laboratory centrifuges.

The rotating compressors according to the invention, thus compressors which are configured, so that the compressing element at least also performs a rotating movement in the compressor cavity help to significantly reduce vibrations of this type, since a rotating movement is always performed in the interior of the compressor, so that no dead centers are created that have to be overcome like for linear compressors.

Advantageously compressors are used as rotating compressors for the laboratory centrifuge according to the invention in which the compressor is a rotating piston compressor, scroll compressor, vane type compressor, wobble plate compressor, screw compressor, spiral compressor and rotary piston compressor or similar, wherein, however, rolling piston compressors and scroll compressors are preferred.

Compressors of this type however are known for refrigerators however, these devices have totally different specifications than laboratory centrifuges. On the one hand laboratory centrifuges are very small compared to refrigerators. Therefore all components have to be housed in very limited installation space. On the other hand laboratory centrifuges include a very fast moving rotator, thus a moving component which has to be operable unencumbered by other components in spite of the limited installation space. Additionally, laboratory centrifuges have to cover a very large temperature range with high reduction rates.

Furthermore only recently rotating compressors have become available which provide at least the same compressing power as a reciprocating compressor with the same dimensions, so that the dimensions of a laboratory centrifuge does not increase when they are being used.

Advantageously the rotating compressors of this type also facilitate reducing the start up currents. Up to now particular laboratory centrifuges were not for sale in some countries, like for example, the USA due to the 110 V AC power grid, since the current peaks generated by powerful reciprocating piston compressors on start up would endanger the stability of the power grids used in these countries. Alternatively, particular controls had to be provided in the laboratory centrifuges which facilitate that the compressor is only controlled, so that the start-up currents do not exceed the legally required values. The rotating compressors provided according to the invention facilitate omitting controls of this type, so that the laboratory centrifuges become simpler in configuration and thus more robust and cost effective and their sale becomes legal in the countries recited supra.

In another exemplary embodiment the rotating compressor is an electrically driven compressor (DC power and/or AC power). Compressors of this type can be built very compact and with high torque and their control can be facilitated e.g. through a controlled switching power supply or a frequency inverter irrespective of the grid voltage. Additionally compressors of this type can also be configured for different power levels in a simpler manner.

It is useful in particular when at least two compressors are disposed parallel to one another. Thus, the compressors can be configured smaller overall and with less power, so that the installation space available in a laboratory centrifuge can be used in a better manner, wherein the overall size for a laboratory centrifuge of this type is reduced.

The laboratory centrifuge according to the invention can be configured in a particularly advantageous manner as a table top laboratory centrifuge and as a micro liter centrifuge since these types of centrifuge require a particularly compact configuration.

It is particularly advantageous when the laboratory centrifuge has a remixing rate of less or equal 20%, preferably less than or equal to 17%, preferably less or equal 14%. Then the remixing rate is particularly high.

### BRIEF DESCRIPTION OF THE DRAWINGS

Features and advantages of the present invention are subsequently described based on an exemplary embodiment with reference to a drawing figure wherein:

FIG. 1 illustrates a laboratory centrifuge according to the invention; and

FIG. 2 illustrates a known laboratory centrifuge.

### DETAILED DESCRIPTION OF THE INVENTION

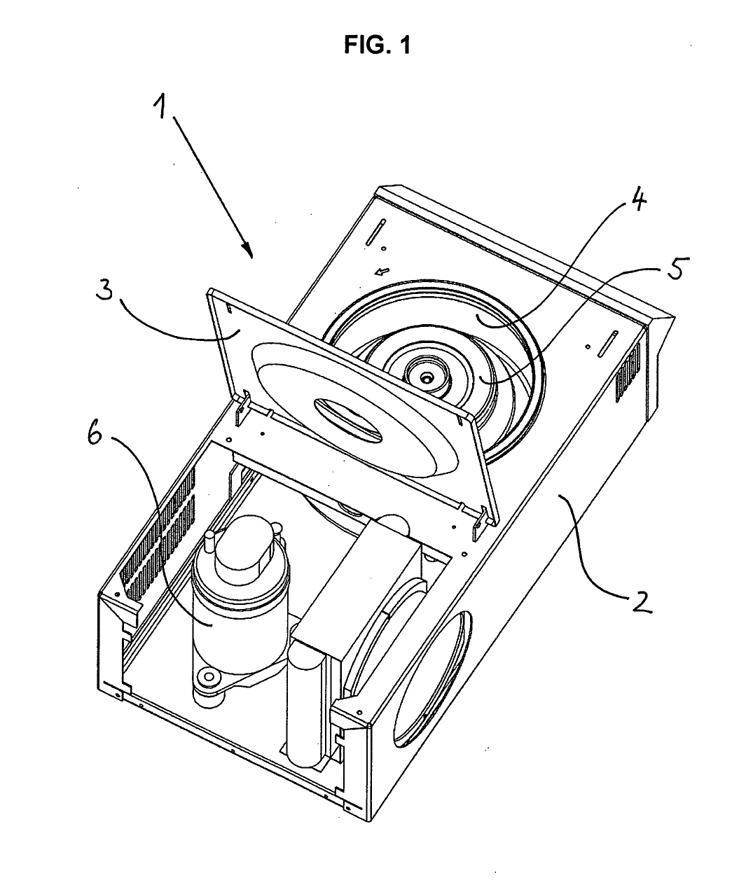

FIG. 1 schematically illustrates the laboratory centrifuge 1 according to the invention in an exemplary embodiment. The laboratory centrifuge 1 includes a housing 2 and a centrifuge cover 3. The centrifuge cover 3 is configured to close a centrifuge container 4 in which a rotor 5 is disposed. The rotor 5 is configured drivable through a motor (not shown) which facilitates centrifuging samples (not shown) disposed at the rotor 5 in order to de-mix the samples.

The laboratory centrifuge 1 includes an active cooling device for cooling the samples, wherein the cooling device includes a compressor 6. The compressor 6 is configured as a rotating compressor and includes a rolling piston compressor. The top side of the housing 2 is not illustrated in the portion of the compressor 6.

The compressor 6 is very compact and has high torque and its control is implemented through a controlled switching power supply irrespective of the grid voltage. The compressor 6 also facilitates smaller power level increments for the refrigeration power in a simple manner.

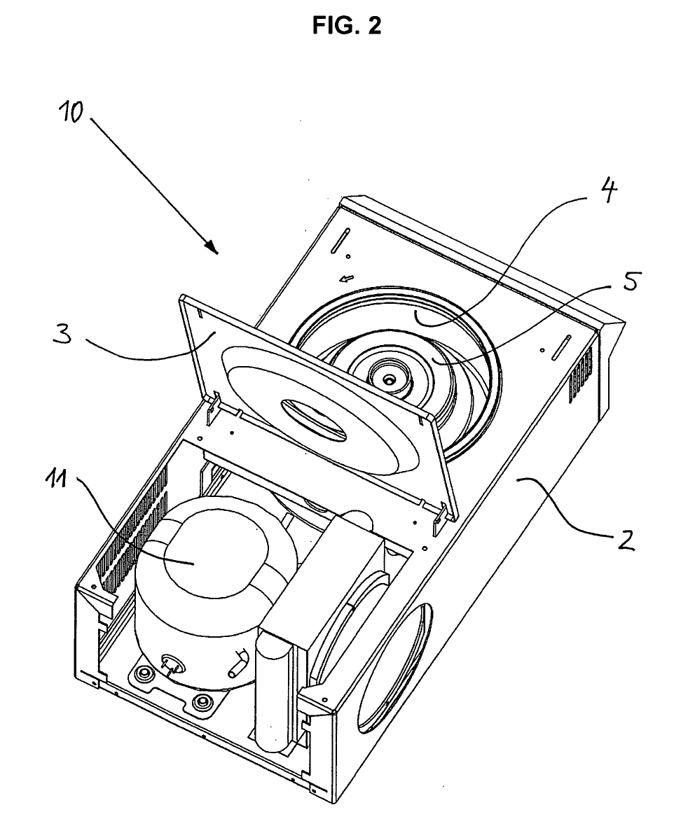

FIG. 2 schematically illustrates a known laboratory centrifuge 10. The laboratory centrifuge 10 differs from the laboratory centrifuge 1 according to the invention in that the compressor 11 is a reciprocating piston compressor. All other components are therefore provided with the same reference numerals as for the laboratory centrifuge according to the invention.

When comparing the laboratory centrifuge 1 according to the invention with the known laboratory centrifuge it becomes apparent that modern rotating compressors 6 require less installation space in the housing 2 for the same power. This way the housing 2 can either be configured smaller or the cooling power can be increased through a parallel installation of plural compressors 6.

Subsequently a comparison of the remixing rates of the laboratory centrifuge 1 according to the invention with the normal laboratory centrifuge 10 including a reciprocating piston compressor is provided. A laboratory centrifuge 1 with a rolling piston compressor XB357 made by Mitsubishi Corporation and a rotor F-45-24-11 made by Eppendorf Corporation was used for a rotor 5. For comparison testing the centrifuge 5415 R made by Eppendorf Coproration (Model SN 5426 0023218) was used for a laboratory centrifuge 10, including a reciprocating piston compressor PL50 made by Danfoss Corporation, wherein the same rotor F-45-24-11 was used for a rotor 5. For dropping the pipettes Eppendorf Reference 500-2500 μl (Model SN 475116) and the Pipette Eppendorf Research pro 5-100 μl (Model SN 022760) were used. Furthermore the Eppendorf Biophotometer (Model SN 6131 00197) was used.

The samples were disposed in 2.0 ml Safe-Lock-Containers (Model U12223342 P 2243) and for producing the samples a 10 mM Tris-solution and a salt concentrate colorant solution with a density of 1.2 g/ml were used. Thus, respectively a 2.0 ml Safe-Lock-Container was dropped with 1450 μl Tris-solution with the pipette Eppendorf Research. Then 50 μl of the salt concentrate colorant solution were disposed thereunder, wherein the pipette was set to the lowest aspiration- and dilution step.

This way four samples were produced respectively for the laboratory centrifuge 1 and the laboratory centrifuge 10, wherein the samples were subsequently centrifuged at 13,200 revolutions per minute and 4° C. for five minutes.

For positive control additionally four 20 ml Safe-Lock-Containers were filled in the same manner and immediately mixed strongly. For negative control four additional 2.0 ml Safe-Lock-Containers were filled in the same manner, wherein the samples, however, were not centrifuged or mixed, but incubated at ambient temperature for 5 minutes.

After the 5 minute centrifugation or diffusion in the containers for positive and negative control 50 μl of the sub-layered salt concentrate solution were removed from the containers through the pipette Eppendorf Research Pro. Subsequently the containers were closed again and stirred vigorously.

The liquid included in the containers was then respectively transferred into a cuvette and measured photometrically at an extinction of a 562 μm. The values generated from the containers for positive control are used as maximum values (100%-values) and the values obtained from the negative control are used as lower threshold (diffusion).

The remixing rate was subsequently computed according to the subsequent formula:

Remixing rate=(centrifuged value−diffusion value)×100/100%-value

The subsequent table shows the obtained results, the right column respectively shows the mean values computed from the four respective samples. For the diffusion the value in parentheses was not used since it was considered an outlier. Based on the determined mean values a remixing rate of 13.44% was determined for the laboratory centrifuge 1 according to the invention, while the remixing rate for the known laboratory centrifuge was 28.26%. The laboratory centrifuge 1 according to the invention facilitates reducing the remixing rate by 15% absolute or by even more than 55% relative.

TABLE

| | Lab Centrifuge 1 | Lab Centrifuge 10 | Mean Value |
|---|---|---|---|
| Diffusion | (0.179%) | | 0.064% |
| | 0.092% | | |
| | 0.046% | | |
| | 0.055% | | |
| Centrifuged | 0.145% | | 0.141% |
| Value | 0.121% | | |
| | 0.138% | | |
| | 0.161% | | |

| | | |
|---|---|---|
| Centrifuged | 0.248 | 0.228% |
| Value | 0.244 | |
| | 0.197 | |
| | 0.222 | |

| | | |
|---|---|---|
| 100%-Value | 0.570% | 0.573% |
| | 0.584% | |
| | 0.576% | |
| | 0.560% | |

It is apparent from the description provided supra that the laboratory centrifuge 1 according to the invention provides much better de-mixing rates for the centrifuged samples since providing at least one rotation compressor 6 according to the invention introduces much less vibration into the laboratory centrifuge 1 so that much lower mixing rates are achieved.

What is claimed is:

1. A laboratory centrifuge, comprising:
a rotor driven by a centrifuge motor; and
a cooling device including a compressor,
wherein the compressor is a rotation compressor.

2. The laboratory centrifuge according to claim 1, wherein the rotation compressor is a compressor selected from a group consisting of rotating piston compressor, scroll compressor, vane type compressor, wobble plate compressor, screw compressor, spiral compressor and rotary piston compressor.

3. The laboratory centrifuge according to claim 1, wherein the rotation compressor is electrically driven.

4. The laboratory centrifuge according to claim 1, wherein at least two compressors are disposed in parallel.

5. The laboratory centrifuge according to claim 1, wherein the laboratory centrifuge is a table top laboratory centrifuge or a micro liter centrifuge.

6. The laboratory centrifuge according claim 1, wherein a remixing rate is less than or equal to 20%.

7. The laboratory centrifuge according claim 1, wherein a remixing rate is less than or equal to 17%.

8. The laboratory centrifuge according claim 1, wherein a remixing rate is less than or equal to 14%.

9. The laboratory centrifuge according to claim 1, wherein the rotation compressor is a DC or AC power driven compressor.
